(19) United States
(12) Patent Application Publication
(10) Pub. No.: US 2004/0179739 A1
(43) Pub. Date: Sep. 16, 2004

(54) Depth map computation

(76) Inventors: Piotr Wilinski, Eindhoven (NL); Fabian Edgar Ernst, Eindhoven (NL)

Correspondence Address: Philips Electronics North America Corporation, P O Box 3001, Briarcliff Manor, NY, 10510, US

(21) Appl. No.: 10/478,524

(22) PCT Filed: May 21, 2002
(86) PCT No.: PCT/IB02/01841

(30) Foreign Application Priority Data
May 23, 2001 (EP) 01201974.1

(51) Int. Cl. G06K 9/36; G06K 9/00; G06K 9/34

(52) U.S. Cl. 382/232; 382/154; 382/173

(57) ABSTRACT

Method for computation of a depth map for a digital image (IM) composed of pixels, with the steps of receiving digital image data (700), receiving singularity data (rec-inf) for the digital image (IM), receiving depth value data (dd) for segments of the digital image (IM), segmenting the digital image (IM) into segments based on the singularity data (rec-inf) by assigning each pixel of the digital image (IM) to a segment, assigning to each segment corresponding depth value data from the received depth value data (dd), and constructing a depth map (800) by assigning to each respective pixel the corresponding depth value data (dd) of the segment to which the respective pixel is assigned.

The invention relates to a method for computation of a depth map for a digital image. The invention further relates to a method for compressing digital image information, a decoder and an encoder for digital image information.

In digital image processing, depth information related to elements of an image is relevant in a number of applications such as for example 3D TV. The depth information is needed to process the video information as to reconstruct 3D images to be shown on the TV screen. Depth information can be extracted out of the subsequent images forming video material in real time in the 3D TV or in a set-top box. This approach has the disadvantage that it is rather costly because of the considerable calculation resources that are required.

It is an object of the invention to provide for a more efficient method for the computation of a depth map of a digital image. The invention provides a method according to claim 1. Depth map reconstruction data is provided for an image by singularity data and depth value data. Singularity data is information relating to singularities or discontinuities in the image that are used for segmenting the image; depth value data is information with respect to the depth assigned to a segment, relative to other segments in the image. Determination of depths of segments in images as such is known in the art. With this information, which does not take up a lot of space or bandwidth, a full depth map can be reconstructed by the receiver of the information. To do this a method according to claim 5 is provided in which the receiver segments the image using a segmentation method, based on the supplied singularity data. Starting from the singularities, forming the segments can be performed with relatively small calculation resources. Finally the depth values are assigned to each segment.

By determining the segments by means of signed distance transform, the method according to the invention is in particular advantageous as singularity data defining the segments, are generated during segmentation in the form of seed points. Therefore, no additional calculations are required to obtain relevant singularity data. The seed points themselves contain enough information to generate a segmentation of an image with relatively small calculation resources. The storage space or bandwidth required by the seed point for an image is relatively small, in particular when the seed points are defined as edge positions composed of a grid point, and an up/down and left/right indicator for the grid point. With each segment generated by the seed points, depth information has to be included, which information again requires only little storage or bandwidth.

Particularly advantageous elaborations of the invention are set forth in the dependent claims. Further objects, elaborations, modifications, effects and details of the invention appear from the following description, in which reference is made to the drawings, in which

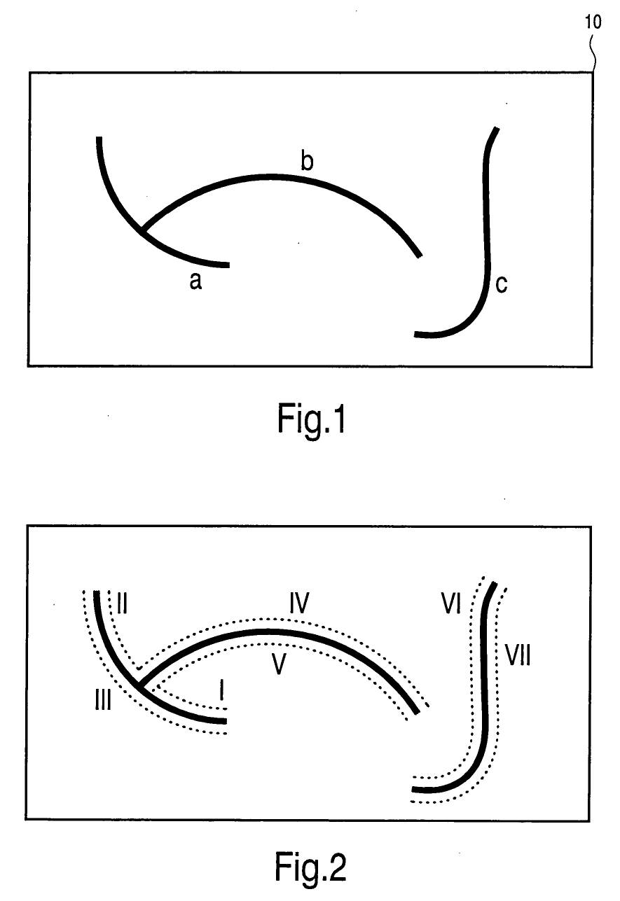

FIG. 1 shows hard edges in an image,

FIG. 2 shows seeds associated with the hard edges of FIG. 1,

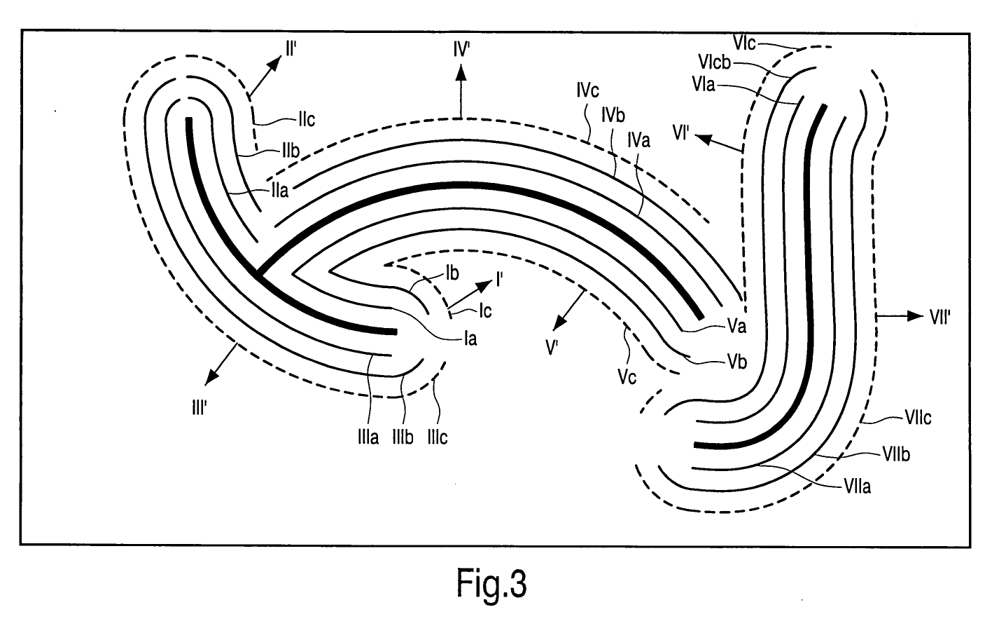

FIG. 3 shows fronts expanding from the seeds of FIG. 2,

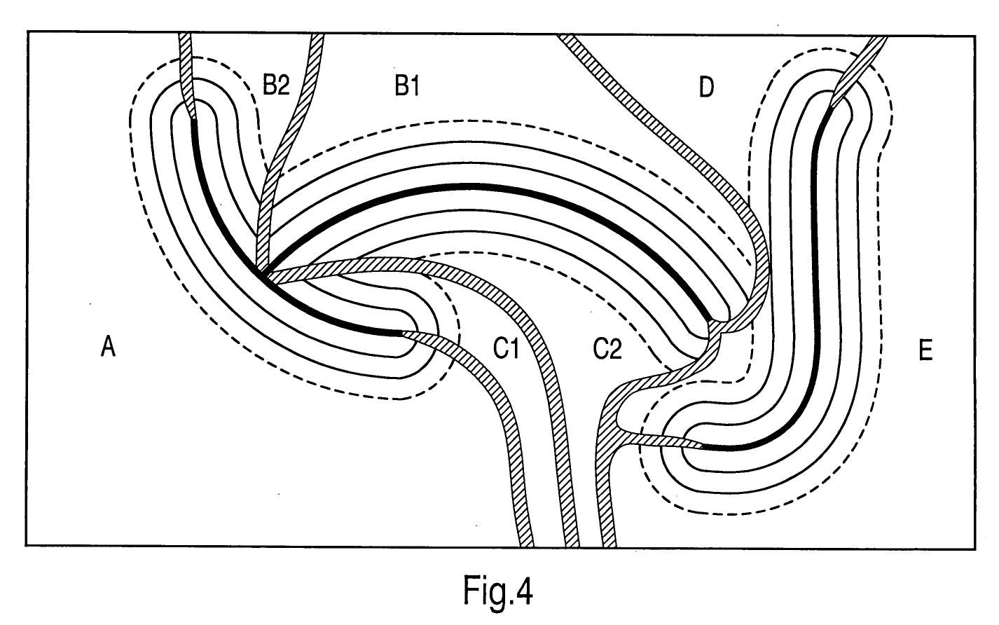

FIG. 4 shows image segments determined by segmentation according to an embodiment of the invention,

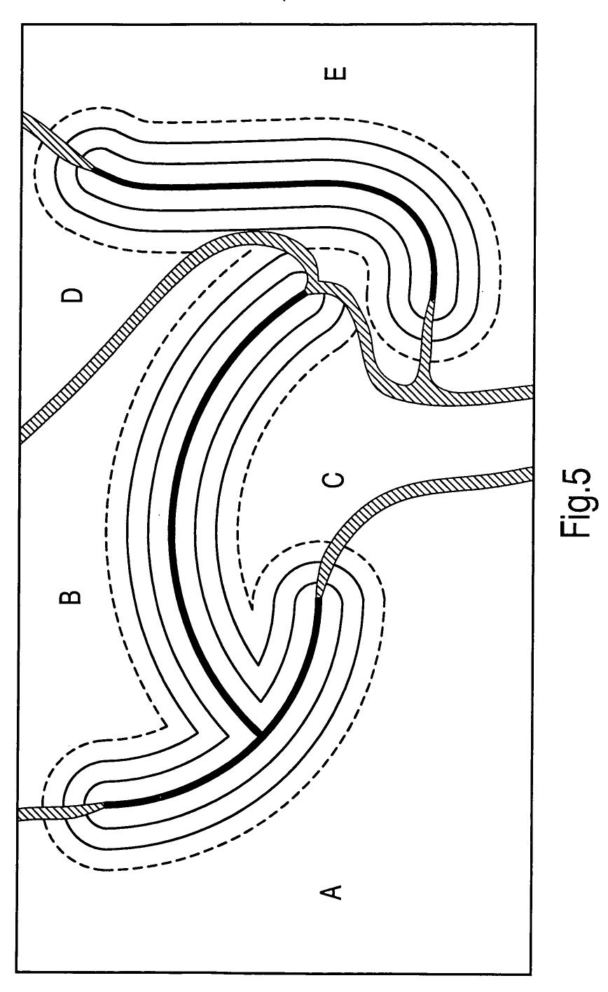

FIG. 5 shows the image segments of FIG. 4 after post-processing,

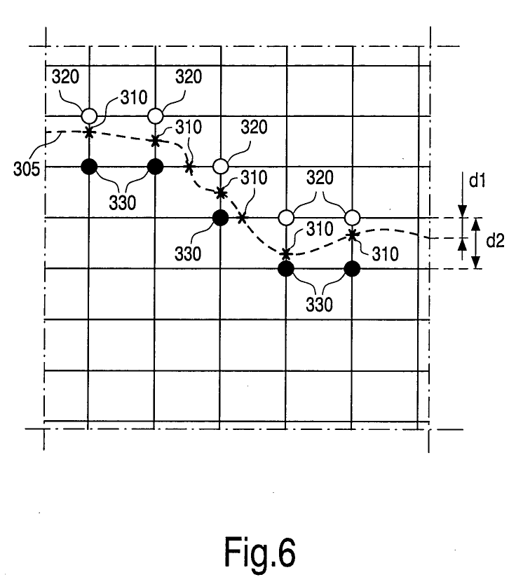

FIG. 6 shows a segment boundary with seed points,

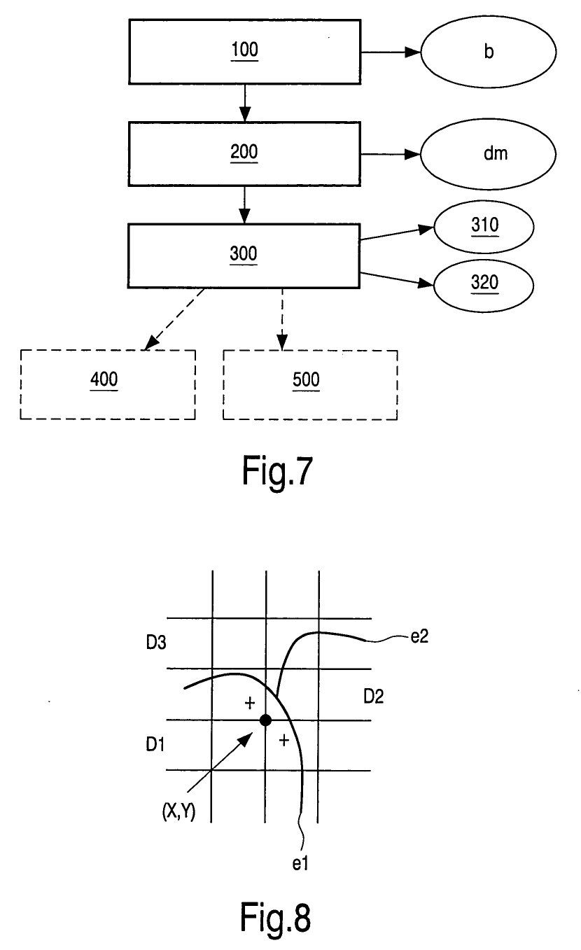

FIG. 7 is a flow chart of an encoding method according to an embodiment of the invention,

FIG. 8 is an illustration of an edge position,

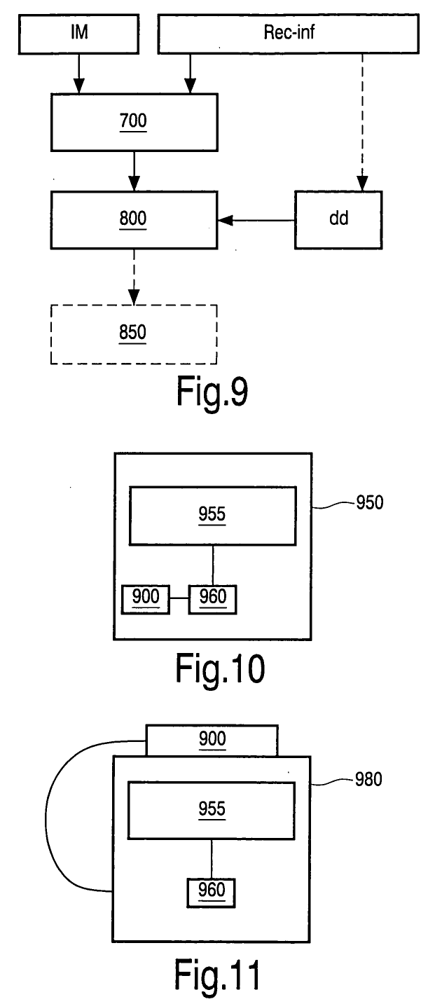

FIG. 9 is a flow chart of a decoding method according to an embodiment of the invention,

FIG. 10 is a television set with an encoder according to an embodiment of the invention,

FIG. 11 is television set with a set top box according to an embodiment of the invention,

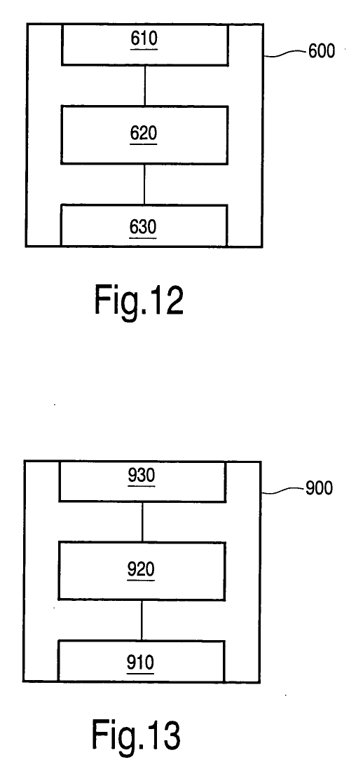

FIG. 12 is an encoder according to an embodiment of the invention,

FIG. 13 is a decoder according to an embodiment of the invention,

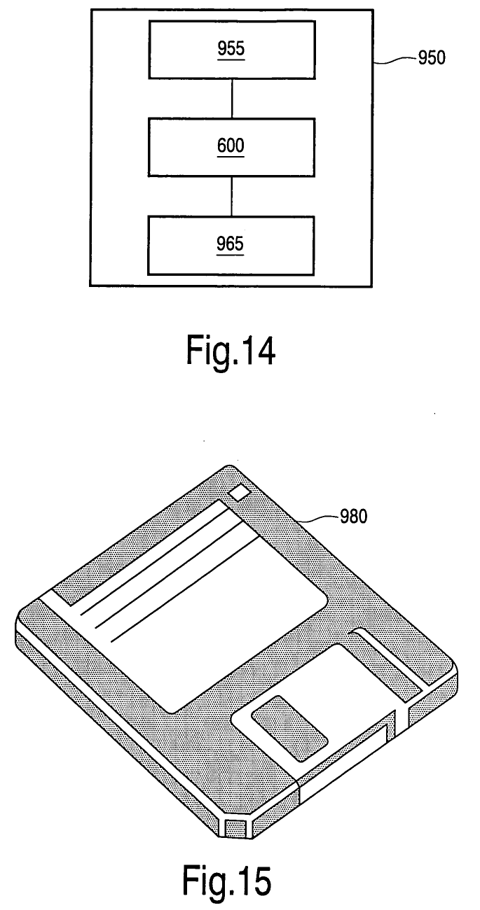

FIG. 14 is a transmitter according to an embodiment of the invention, and

FIG. 15 is a storage medium provided with data files stored on it according to an embodiment of the invention.

In the following an example of a method according to the invention will be described. In the example, a digital image M composed of pixels will be described. Such an image can for example be an image comprised in a video data stream; although the example will deal with a single image, the invention is in particular suited to be used for multiple, subsequent images.

According to the invention, the processing of the image comprises dividing the image into segments (segmentation). An efficient method of dividing the image into segments, called quasi-segmentation, is described below.

In the following examples of the quasi-segmentation use will be made of segmenting a digital image into separate regions. The digital image is composed of image pixels. Segments to be formed in the image are bounded by borders or border lines; pixels within the borders of a segment belong to that segment. Therefore the determination of the borders leads to the determination of the segments.

To obtain borders or at least fragments of borders, the digital image is processed to find edges in the image using an edge detection process, in which image features are analyzed. Edges that are detected result from image features, and have therefore a high probability to be a boundary between image objects. The edges detected by the edge detection process are used as fragments of the borders between the segments to be determined. These border fragments resulting directly from image information are called hard border fragments or high probability border fragments.

In FIG. 1 hard border fragments detected in the image with an edge detection method are shown in image 10 which has the same size as the digital image. Three hard border fragments have been detected, border fragments a, b, and c respectively. Note that border fragment b is incident at border fragment a; this topography is known as a bifurcation.

Edge detection methods per se are well known in the art. In this example the hard border fragments are determined by high contrast borders, which are a good indication of a border between image elements. Other criteria for border fragments between image elements can be used such as color, luminance, or texture.

The hard border fragments a, b, c bound part of a segment; the borders of the segments are not complete however. The other sections of the borders have to be established. The other border sections are determined by the distance to the closest hard border section. To obtain the other border sections, sides of the border fragments a, b, and, c are defined and uniquely labeled. As shown in FIG. 2, border section b has a first side IV and a second side V, and border section c has therefore a first side VI and a second side VII. Border section a has a first side III; the other side of border section a is divided in two sections by border section b in the position where border b intersects border section a. The respective sections are sides I and II of border section a.

To obtain the other boundaries, the sides I-VII are expanded in a direction away from the border fragment from which they originate, the respective expansion directions being indicated by arrows I′-VII′ in FIG. 3. Preferably, the direction of expansion is essentially perpendicular to the previous front. A number of expanding fronts, labeled Ia/b/c-VIIa/b/c, respectively, have been indicated in FIG. 3, wherein the suffix -a denotes fronts close to the original edge, and the suffixes -b and -c respectively denote subsequent fronts further from the original border fragment. In fact each front is the locus of point having the same distance to the closest border fragment. Where the expanding fronts meet neighboring expanding fronts, a border fragment is formed, as indicated by the hatched lines in FIG. 4. These border fragments are called soft border fragments as they do not derive directly from information of the image. The soft border sections are essentially contiguous to the end sections of hard border sections. Non contiguous soft border sections can however occur, e.g. when hard border sections extend up to the edge of the image. The probability that a soft border is a part of a border of a segment is lower than that of the aforementioned hard borders. After full expansion of the fronts up to the edge of the image, segments are defined as shown in FIG. 4, indicated by capitals A-E. The soft boundaries are labeled by the two segments they divide. As a result the complete image has been divided in segments A-E, wherein each segment is bound at least partially by a hard border and further by soft borders or the image edge. Subsequently, the obtained segmentation can be scanned for oversegmented regions, that logically form a single segment. In this example the borders between segments B1-B2 and C1-C2 are redundant, as a result of oversegmention, caused by the bifurcation of border a and b. After detection of such oversegmentation, the segments B1, B2 and C1, C2 can be merged.

Consequently, image pixels can uniquely be assigned to a segment, bound by the hard and soft borders sections, as established in the above explained manner. Note that the segments consist of groups of pixels that share the same closest side of a hard border fragment.

The segmentation as obtained with this method is called a quasi segmentation, wherein some sections of the boundaries of the segments are less strict defined, with a lower degree of certainty (the above described soft border sections). This quasi segmentation has the advantage that it results in a segmentation which is accurate in sections of the borders where the segmentation can be determined easily, and less accurate in sections where determination is more difficult. This results in significantly decreased calculation costs, and increased calculation speeds. The quasi segments can for example be used in matching of segments in subsequent images.

In the following an implementation of quasi segmentation will be described. The digital image to be segmented in this example is a discrete image IM (x, y) with pixels (x, y) of a resolution N×M, wherein N and M are integers. A binary picture I(x,y) with pixels (x, y) of resolution N×M is defined; the binary picture I(x,y) is used for the determination of the segments of the image IM as hereinafter described. Also defined are an array d(x,y), called the distance array with size N×M and an array b(x, y), called the item buffer, again with size N×M. In the distance array d(x,y) for every pixel (x,y) the distance to a closest seed (as defined below) is stored; the determination of this distance will be explained in the following. In the item buffer array b(x,y) is stored for every pixel (x,y) the identity of the closest seed or border fragment; in the following the determination of the closest seed or border will be explained.

First the digital image IM is processed with an edge detector to determine well defined edges; this step is similar to the detection of hard border fragments mentioned before. By way of example the known Marr-Hildreth method is used in this embodiment, as described by E. C. Hildreth, in “The detection of intensity changes by computer and biological vision systems” published in 1983 in Computer vision, graphics and Image processing, pag. 22:1-27. The Marr-Hildreth algorithm uses zero crossings of a Laplacian of Gaussian (LoG) operator to detect border fragments.

The Marr-Hildreth method detects zero crossings of the LoG in between two pixels of the discrete image IM, which are considered as points on hard border fragments as in the first embodiment. In FIG. 6 a section of an image matrix is shown, with the intersections of the grid indicating the location of the pixels. The line 305 indicates the zero crossings, indicated by the asterisks (*) 310, detected by means of the LoG operator. The hard borders found in the image by the LoG zero crossings detection are mostly extended contiguous sequences of inter pixel positions. With each zero crossing, that lies between two pixels, two seed pixels are associated on either side of the crossing; the border 305 passes in between the two seed pixels. In this embodiment a seed consists of seed pixels, wherein seed pixels are the pixels of the image that are closest to the hard border sections. The seeds form an approximation of the border sections within the digital image pixel array; as the seeds fit within the pixel array, subsequent calculations can be performed easily. Other methods of determining seeds on basis of found hard border sections can be used. The pairs of seed pixels opposite the border 310 are indicated by the circles 320 and the black dots 330 in FIG. 6.

Seed pixels are defined all along the detected hard border 305, giving rise to two-pixel wide double chains. Each chain of seed pixels along a side of the border (i.e. each one-pixel wide half of the double chain) is regarded as a seed, and accordingly indicated by a unique identifier. As the hard border in this example is defined by a zero crossing of the LoG operator, the value of LoG is positive on one side of the border and negative on the other side. Identification of the different sides of the border can be achieved according to the invention by using the sign of the LoG operator. This is advantageous as the LoG operator has already been calculated during the process. Because of the use of the LoG operator the method of segmentation can also be referred to as Signed Distance Transform.

As a result of the LoG based edge detection the seed pixels essentially form chains; however, seeds can be arbitrarily shaped clusters of edge pixels, in particular seeds having a width of more than a single pixel.

In the item buffer b(x,y), the value corresponding with the position of a seed point is given the value of the unique seed identifier. Initially, all other pixels, which are not seed points, do not have a seed identifier number in the item buffer b(x,y), but are given a value that does not correspond to a seed identifier number.

For each pixel of the image IM(x,y) which is found to be a seed pixel, the pixel with the corresponding coordinates (x,y) in the binary image I is given the value 1. All other pixels in the image I are given the value 0.

By means of for example linear interpolation of the values in the LoG-filtered image, an estimation can be made for the sub-pixel distances between the actual zero crossing 310 and the respective pair of seed pixels 320, 330. As shown in FIG. 6 for the pair of pixels at the farthest right hand side, the respective distances are d1 and d2, wherein d1+d2=1, wherein the grid size for the pixel distance is the unit distance 1. The respective values for d1 and d2 are assigned to d(x,y) for the respective seed pixels. The distance array d is further initialized by assigning a distance corresponding to infinity within the distance system used to pixel positions not on a seed.

A distance transform gives, for every pixel (x, y) the shortest distance d(x,y) to the nearest seed point. Any suitable definition for the distance can be used, such as the Euclidean, “city block” or “Manhattan” distance. Methods for calculating the distance to the nearest seed point for each pixel are well known in the art, and implementing the invention any suitable method can be used. By way of example an algorithm may be used for the computation of the distance transform as described by G. Borgefors in “Distance transforms in arbitrary dimensions”, published in 1984 in Computer vision, graphics and Image processing, pag. 27:321-345, and in particular the disclosed method for the two dimensional situation.

This algorithm is based on two passes over all pixels in the image I(x,y), resulting in values for d(x,y) indicating the distance to the closest seed. The values for d(x,y) are initialized as mentioned before. In the first pass, from the upper left to lower right of image I, the value d(x,y) is set equal to the minimum of itself and each of its neighbors plus the distance to get to that neighbor. In a second pass, the same procedure is followed while the pixels are scanned from the lower right to upper left of the image I. After these two passes, all d(x,y) have their correct values, representing the closest distance to the nearest seed point.

During the two passes where the d(x,y) distance array is filled with the correct values, the item buffer b(x,y) is updated with the identification of the closest seed for each of the pixels (x,y). After the distance transformation, the item buffer b(x,y) has for each pixel (x,y) the value associated with the closest seed. This results in the digital image being segmented; the segments are formed by pixels (x,y) with identical values b(x,y).

In the second example the distances that are computed further in the distance transform algorithm are non-integer values, for example a real number, because of the linear interpolation of the starting values of d(x,y). When comparing for a pixel (x,y) the real-valued d(x,y) values representing the shortest distances to two different seeds, the chance that both distances are different is very large. This allows a unique identification of every pixel as belonging to one single segment. If distances were to be measured in integer values, arbitrary choices would have to be made for each of many pixels that would have the same distance to two seeds. This would lead to increased raggedness (and therefore reduced accuracy) of the border, but with lower calculation power requirements.

In FIG. 7 a flow chart for a method for encoding a digital image according to the invention is shown.

The first step of the processing of the digital image M is the segmentation 100 of the image, for example using the above described method of quasi-segmentation. In short, the image is scanned for singularities as required in quasi-segmentation, in particular luminosity edges. Pixels surrounding the found edges are used to determine seed points, making up seeds. The seeds are expanded to form segments. As shown above the result of this segmentation is that each pixel of the image is assigned to a segment, a segment therefore being a group of pixels. The results are the locations of the seeds within the image, and a filled out item buffer b.

In a subsequent step 200 depth values for each segment and therefore each pixel in the item buffer are determined, yielding a depth map dm. Determination of depth values per se is known from the art, and according to the invention any suitable method can be used.

In step 300 the information with respect to the depth values determined for the image is compressed. This is done by composing depth reconstruction information for the digital image, based on the information resulting from the segmentation and depth analysis. On basis of the reconstruction information a depth map for the image can be reconstructed.

To achieve this, in the reconstruction information only the edge positions of the segments 310 are included together with the depth value data 320 of the segment that is engendered by the segment. The receiver can use this reconstruction information to regenerate a depth map for the digital image, using the above described segmentation method, starting with the edges provided. It is noted that in the quasi-segmentation the step that requires the most calculation resources is the determination of the singularities. Once the singularities are known, forming the segments can be performed with relatively small calculation resources.

The edge information can be coded as follows. In FIG. 8 a section of a grid of an image is shown. Parts of three segments D1, D2, and D3 are shown, separated by two edges e1, e2. For storing the edge information an edge position needs

the coordinate of a grid point (x, y) to which the edge is attributed,

information of the presence or absence of an edge crossing the grid at the upper side of grid point (x, y),

information of the presence or absence of an edge crossing the grid at the right side of grid point (x, y), and

the depth values of the engendered segments.

For the situation of FIG. 8, the edge crossings are respectively at the upper and right side of the grid point (x, y), indicated accordingly with a + sign. For the definition of the item buffer the precise location of the zero crossings on the edge between the grid points (d1, and d2 shown above) is not required. Therefore the presence information can sufficiently be represented by a binary or Boolean parameter.

Alternatively, the edge information can be coded using the information with respect to the seeds found in the segmentation process. In this case the data to be transmitted comprises:

the seed pixel coordinates,

the respective seed numbers, and

a table attributing depth values to seed numbers.

The number of seed pixel coordinates is roughly twice that of the number of edge positions; therefore transmitting edge information through seed pixel coordinates requires a larger data transmission. The reconstruction of the segments is slightly faster, because there is no need to reconstruct the seed points.

Subsequently, in a following step 400, shown in phantom in FIG. 7, the digital image is transmitted to a receiver, together with the reconstruction information. Depending on the transmission protocol used, the reconstruction information can be transferred using a parallel communication channel, for example as provided in MPEG. Alternatively, the reconstruction information can be stored on a data carrier, such as for example a Digital Versatile Disk, CD and CD-ROM, shown in phantom in FIG. 7 as step 500, preferably together with the digital image information, using a suitable storage method, such as MPEG. The data determined in step 300 is consecutively output, shown in phantom in FIG. 7 as steps 400 and 500.

According to the invention an encoder device 600 for compressing digital image information is provided, as shown in FIG. 12. The device 600 comprises an input section 610 for receiving digital images composed of pixels, a processing unit 620 for segmenting a digital image based on singularities in the digital image by assigning each pixel of the digital image to a segment, and for determining of depth value data for each segment of the image, and an output means 630 for outputting depth reconstruction information for the digital image, comprising said singularity data and depth value data. Preferably the processing unit 620 is provided with a computer program for performing the steps 100, 200, 300 of the encoding method described above. The invention is however not limited to this implementation. Other ways of implementation can be used, for example using dedicated hardware, such as a chip.

In FIG. 14 a transmitter 950 according to the invention is shown, provided with an encoder 600 as described above. The transmitter is further provided with an input section 955 for receiving image information and an output section 965, embodied in this example as a send device. The send device 965 is adapted to generate a output signal, for example a digital bit stream signal or a signal suitable for broadcasting. The signal generated represents a digital images and comprises singularity data for the digital image, and depth value data for segments of the digital image.

The information transmitted or read from a data carrier as produced by the above described method is processed by a receiver, as shown in a flow chart in FIG. 9. The receiver receives (step 700) the image information IM and the reconstruction information rec-inf, the reconstruction information being formed by the singularity information and the depth values. Using the reconstruction information rec-inf, the segmentation of each image of the image information is reconstructed, and the depth map for the image formed (step 800) by using the depth value data dd contained in the reconstruction information. The depth map can subsequently be used for displaying the image information as shown in phantom as step 850.

The method of encoding the information encoded according to the above mentioned steps 100, 200, 300 comprises receiving digital image data, receiving singularity data and depth value data for segments of the digital image. As shown before, the singularity data forms the basis for finding a segmentation. Two examples are shown, the first one comprising singularity data in the form of edge information and the second one comprising singularity data in the form of seed information. According to the above mentioned method of segmentation, using either edges or seeds, a segmentation and corresponding item buffer of the image can be calculated. Consequently, a depth map can be constructed by matching the depth information provided with the received information to the item buffer. This results in a depth map in which each pixel is provided with a depth value. Forming segments starting from singularities, such as edges or seeds, is a relatively easy operation which does not require large calculation resources.

According to the invention an decoder device 900 for computation of a depth map for a digital image composed of pixels is provided as shown in FIG. 13. The decoder 900 comprises an input section 930 for receiving digital image data, singularity data for said digital image, and depth value data for segments of said digital image, processing section 920 for segmenting a received digital image into segments using said singularity data by assigning each pixel of said digital image to a segment, and for constructing a depth map by assigning to each respective pixel the received depth value data of the segment to which the respective pixel is assigned, and an output section 910 for outputting said depth map. Preferably the processing unit 920 is provided with a computer program for performing the steps 700, 800, 850 of the encoding method described above.

In FIG. 10 a television 950 is shown, provided with a decoder 900, the output section of which decoder 900 is connected to a display driver unit 960 for a television display 955. In FIG. 11 a television 980 is shown, provided with a television display 955 and a display driver unit 960. The television is connected to a decoder 900 which is implemented as a set top box. A video signal comprising reconstruction information as described above can be fed to the television 950 directly, after which the decoder 900 processes the information so the driver 960 can display the images on the display 955. Accordingly, a video signal comprising reconstruction information as described above can be fed to the set top box shown in FIG. 11, after which the decoder 900 processes the information and feeds it to the television 980 so that the driver 960 can display the images on the display 955.

The steps of the method of decoding and encoding according the invention as described above, can be performed by program code portion executed on a computer system. The invention therefore further relates to a computer program with code portions that when executed on a computer system perform the steps of encoding and/or decoding. Such a program can be stored in any suitable way, for example in a memory or on an information carrier, such as a CD-ROM or floppy disk 980, as shown in FIG. 15.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. Method for computation of a depth map for a digital image (IM, M) composed of pixels, comprising
receiving digital image data,
characterized by
receiving singularity data (rec-inf) for said digital image (IM, M),
receiving depth value data (dd) for segments of said digital image (IM, M),
segmenting said digital image (M, IM) into segments based on said singularity data (rec-inf) by assigning each pixel of said digital image (IM, M) to a segment,
assigning to each segment corresponding depth value data from said received depth value data (dd), and
constructing a depth map (dm) by assigning to each respective pixel the corresponding depth value data (dd) of the segment to which the respective pixel is assigned.

2. Method according to claim 1, further comprising
segmenting said digital image (IM, M) by means of signed distance transform.

3. Method according to claim 2, wherein segmenting said digital image (IM, M) by means of signed distance transform further comprises
determining seeds associated with said singularity data,
expanding the found seeds to fill an item buffer (b), and
constructing a depth map (dm) by attributing corresponding received depth value data (dd) to the item buffer (b).

4. Method according to claim 2, wherein segmenting said digital image (IM, M) by means of signed distance transform further comprises expanding seeds and seed numbers included in said singularity data to fill an item buffer (b), and
constructing a depth map (dm) by attributing corresponding received depth value data (dd) to the seed numbers in the item buffer (b).

5. Method for compressing digital image information comprising
determining singularities in a digital image (IM, M) composed of pixels,
characterized by
segmenting a digital image (IM, M) based on said determined singularities by assigning each pixel of said digital image (IM, M) to a segment,
determining of depth value data (dd) for each segment of said image (IM, M),
determining singularity data for said digital image (IM, M), and
composing depth reconstruction information (rec-inf) for said digital image (IM, M), comprising said singularity data and depth value data (dd).

6. Method according to claim 5, further comprising segmenting said digital image (IM, M) by means of signed distance transform.

7. Method according to claim 6, wherein segmenting said digital image (IM, M) by means of signed distance transform further comprises
finding seeds associated with said singularity data,
expanding the found seeds to fill an item buffer (b), and
constructing a depth map (dm) by attributing corresponding depth value data to the item buffer (b).

8. Method according to any one of claims 5-7, further comprising
determining edges as singularities in said digital image, determining as singularity data edge positions comprising
a grid point,
an up/down indicator associated with said grid point, and
an left/right indicator associated with said grid point.

9. Method according to claim 8, wherein a Boolean parameter is used for the respective up/down indicator and left/right indicator.

10. Method according to claim 7, further comprising
determining seed points as singularities in said digital image,
determining as singularity data seeds comprising
seed pixel coordinates,
associated seed number,
depth value data associated with said seed number.

11. Method according to claim 5, further comprising
transmitting said digital image and said depth reconstruction (rec-inf) information to a receiver.

12. Method according to claim 5, further comprising
storing said digital image (IM, M) and said depth reconstruction information (rec-inf) on a data carrier (980).

13. Decoder device for computation of a depth map (dm) for a digital image (IM, M) composed of pixels, comprising
an input section (610) for receiving digital image data, singularity data for said digital image (IM, M), and depth value data (dd) for segments of said digital image (IM, M),
processing section (620) for segmenting a received digital image (IM, M) into segments using said singularity data by assigning each pixel of said digital image (IM, M) to a segment, and for constructing a depth map (dm) by assigning to each respective pixel the corresponding received depth value data (dd) of the segment to which the respective pixel is assigned, and
an output section (630) for outputting said depth map (dm).

14. Encoder device for compressing digital image information comprising
an input section (610) for receiving digital images (IM, M) composed of pixels,
a processing unit (620) for segmenting a digital image (IM, M) based on singularities in said digital image (IM, M) by assigning each pixel of said digital image (IM, M) to a segment, and for determining of depth value data (dd) for each segment of said image (IM, M), and
an output means (630) for outputting depth reconstruction information (rec-inf) for said digital image (IM, M), comprising said singularity data and depth value data (dd).

15. A television provided with a display (955), a display driver (960), and a decoder (900) according to claim 13.

16. A transmitter provided with an encoder (600) according to claim 14, a sending device (965).

17. A digital signal representing a digital image comprising singularity data for said digital image (IM, M), and depth value data for segments of said digital image (IM, M).

18. A data carrier on which a signal as claimed in claim 17 has been stored.

19. Computer program comprising code portions that when executed on a computer system perform the steps of claim 1.

20. Computer program comprising code portions that when executed on a computer system perform the steps of claim 5.
